(19) United States
(12) Patent Application Publication
(10) Pub. No.: US 2005/0152594 A1
(43) Pub. Date: Jul. 14, 2005

(54) Method and system for monitoring IC process

(75) Inventors: Jack Jau, Los Altos, CA (US); Srinivasan Sundararajan, Milpitas, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hermes-Microvision, Inc., Hsinchu (TW)

(21) Appl. No.: 10/985,742

(22) Filed: Nov. 9, 2004

Related U.S. Application Data
(60) Provisional application No. 60/518,865, filed on Nov. 10, 2003.

(51) Int. Cl. G06K 9/00

(52) U.S. Cl. 382/145

(57) ABSTRACT

A method and system for determining process uniformity. The method includes selecting a plurality of sample regions. The plurality of sample regions includes a plurality of processed features, and each of the plurality of sample regions includes at least one of the plurality of processed features. Each of the plurality of processed features results from at least one fabrication process. Additionally, the method includes obtaining a plurality of electron microscope images associated with the plurality of sample regions respectively, processing information associated with the plurality of electron microscope images, and, determining a first plurality of grayscale values for the plurality of sample regions respectively. Moreover, the method includes processing information associated with the first plurality of grayscale values, and determining whether the at least one fabrication process is uniform.

### CROSS-REFERENCES TO RELATED APPLICATIONS

This application claims priority to U.S. Provisional No. 60/518,865, filed Nov. 10, 2003, which is incorporated by reference herein for all purposes.

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK.

NOT APPLICABLE

### BACKGROUND OF THE INVENTION

The present invention is directed to integrated circuit (IC) fabrication. More particularly, the invention provides a method and system for examining IC process uniformity. Merely by way of example, the invention has been applied to inline monitoring. But it would be recognized that the invention has a much broader range of applicability.

Integrated circuit (IC) processing has become increasingly challenging as feature sizes continue to shrink. Shrinking dimensions and increasing wafer sizes are making the maintenance of process uniformity throughout the wafer important but difficult to attain. Process windows are rapidly narrowing in advanced wafer manufacturing, and process variations can happen as inadequate time is spent to perfect the process due to the economic pressure of higher average selling price for the latest technology.

Process variation can manifest itself in different forms. Spatial variation across the wafer results from equipment or process disturbances or limitations. These variations may be further amplified by patterning differences within the die. There are multiple ways of measuring the wafer characteristics to achieve process control, such as inline monitoring conducted after one process and before the other commences, in-situ operation while processing is in progress and offline operation. In order to maintain inline control of the process, one needs to understand the variations across time between different lots and/or wafers, and, also within the wafer as well as within the die. The decision of where to inspect within the die and which dies to inspect in the wafer is one that often requires careful planning and attention to detail. Making too few measurements may be inadequate whereas making too many measurements can make the data collection and processing unnecessarily tedious. Sometimes, test structures can be located on the scribe line and they offer one method to decide on a suitable feature to inspect.

Some conventional inspection protocols involve bare wafer analysis for process tool qualification and to make sure that there is no particle problem. This is often necessary at first to ensure that the process tool is operating properly and does not act as a source of yield-killing particles. This is usually followed by optical inspection of the processed and patterned wafers, and then followed by e-beam inspection. Wafer-level variation is often characterized by low spatial frequency trends that are caused by equipment design and/or operation limitations.

For example, dielectric etch is a unit operation that is an integral part of dual damascene processing as well as of subtractive etch processing. With advanced semiconductor manufacturing technology, the etch process for high aspect ratio structures, e.g., contact and/or via holes in dual damascene, has become increasingly challenging due to its small critical dimensions. The common problems include unopened contact and/or via holes and non-uniform etching across the whole wafer. For example, defects in the contact etch process may render integrated circuits inoperative, and therefore etch process parameters need to be controlled, monitored and optimized to ensure a good yield. As another example, a via includes a trench, such as one used for shallow trench isolation.

Before e-beam inspection became more widely used, conventional CD-SEM technology could provide critical dimension of the hole top verses that of the hole bottom but this metric often could not reveal anything about the electrical characteristics of the contact hole. If it was able to distinguish between normal and under-etched conditions at all, the distinction was often made indirectly, with questionable reliability. As another example, some defect inspection tools based on scanning electron microscopy (SEM) coupled with computational processing power have been used for detecting defects such as unopened contact and/or via holes. But the limitation of these tools is that while they can help in the detection of defective contact and/or via holes, they are not able to provide any information about the etching variation or uniformity across a wafer. As yet another example, EB-Scope technology has used a similar principle. In the EB-scope technology, electron beam induced substrate current is used to estimate the residue thickness at the bottom of contact or via holes. But the EB-scope technology is slow and has problems on modified substrates such as silicon-on-insulator (SOI), that are becoming popular due to their advantages.

The same issues that are seen with monitoring etch uniformity are often present in wafers after any other unit operation during IC manufacturing. Another example would be chemical mechanical polishing (CMP). In fact, narrow process windows and large wafer sizes have given raise to process variations in numerous integrated circuit fabrication processes such as etch, deposition, CMP, and electrochemical plating (ECP).

Hence it is highly desirable to improve techniques for monitoring IC process uniformity.

### BRIEF SUMMARY OF THE INVENTION

The present invention is directed to integrated circuit (IC) fabrication. More particularly, the invention provides a method and system for examining IC process uniformity. Merely by way of example, the invention has been applied to inline monitoring. But it would be recognized that the invention has a much broader range of applicability.

According to one embodiment of the present invention, a method for determining process uniformity includes selecting a plurality of sample regions. The plurality of sample regions includes a plurality of processed features, and each of the plurality of sample regions includes at least one of the plurality of processed features. Each of the plurality of processed features results from at least one fabrication process. Additionally, the method includes obtaining a plurality of electron microscope images associated with the plurality of sample regions respectively, processing information associated with the plurality of electron microscope images, and determining a first plurality of grayscale values for the plurality of sample regions respectively based on at least information associated with the plurality of electron microscope images. Each of the first plurality of grayscale values is associated with the at least one of the plurality of processed features. Moreover, the method includes processing information associated with the first plurality of grayscale values, and determining whether the at least one fabrication process is uniform based on at least information associated with the first plurality of grayscale values.

According to another embodiment, a method for determining process uniformity includes selecting a plurality of sample regions. The plurality of sample regions includes a plurality of processed features, and each of the plurality of sample regions includes at least one of the plurality of processed features. Each of the plurality of processed features results from at least one fabrication process. Additionally, the method includes obtaining a plurality of electron microscope images associated with the plurality of sample regions respectively, processing information associated with the plurality of electron microscope images, and determining a first plurality of grayscale values for the plurality of sample regions respectively based on at least information associated with the plurality of electron microscope images. Each of the first plurality of grayscale values is associated with the at least one of the plurality of processed features. Moreover, the method includes generating a first contour map based on at least information associated with the first plurality of grayscale values, processing information associated with the first contour map, and determining whether the at least one fabrication process is uniform based on at least information associated with the first contour map.

According to yet another embodiment, a system for determining process uniformity includes an electron microscope system configured to obtain a plurality of electron microscope images associated with a plurality of sample regions respectively. The plurality of sample regions includes a plurality of processed features, and each of the plurality of sample regions includes at least one of the plurality of processed features. Each of the plurality of processed features results from at least one fabrication process. Additionally, the system includes a processing system configured to process information associated with the plurality of electron microscope images, and determine a first plurality of grayscale values for the plurality of sample regions respectively based on at least information associated with the plurality of electron microscope images. Each of the first plurality of grayscale values is associated with the at least one of the plurality of processed features. Moreover, the processing system is further configured to process information associated with the first plurality of grayscale values, and determine whether the at least one fabrication process is uniform based on at least information associated with the first plurality of grayscale values.

According to yet another embodiment, a system for determining process uniformity includes an electron microscope system configured to obtain a plurality of electron microscope images associated with a plurality of sample regions respectively. The plurality of sample regions includes a plurality of processed features, and each of the plurality of sample regions includes at least one of the plurality of processed features. Each of the plurality of processed features results from at least one fabrication process. Additionally, the system includes a processing system configured to process information associated with the plurality of electron microscope images, and determine a first plurality of grayscale values for the plurality of sample regions respectively based on at least information associated with the plurality of electron microscope images. Each of the first plurality of grayscale values is associated with the at least one of the plurality of processed features. Moreover, the processing system is further configured to generate a first contour map based on at least information associated with the first plurality of grayscale values, process information associated with the first contour map, and determine whether the at least one fabrication process is uniform based on at least information associated with the first contour map.

Many benefits are achieved by way of the present invention over conventional techniques. For example, some embodiments of the present invention provide a semiconductor wafer measurement and inspection technique to accurately monitor and visualize processing conditions such as uniformity or variation of particular processes within a die, within a wafer, between wafers within a lot, and/or between lots. Certain embodiments of the present invention provide contour maps representing average grayscale values for the background, average grayscale values for processed features, and adjusted grayscale values. These two-dimensional contour maps can serve as reliable indicators of overall process conditions across an entire wafer and/or between wafers. Some embodiments of the present invention provide quick visual representation using sample region images as well as grayscale values for the processed features and the background. For example, the visual representation takes the form of contour plots and clearly shows wafer level variations. Certain embodiments of the present invention use sample regions within a die to determine process uniformity within a die or designated sample regions within a wafer to determine the process uniformity within a wafer. Some embodiments of the present invention enable a process engineer to get a quick synopsis of the process performance across the wafer, supported by statistically quantitative measures. For example, a lot of data can be generated by e-beam inspection, which may be highly voluminous to handle and thereby making its significance difficult to understand. With quick visualization and comparative analysis of the data in a concise manner, appropriate process corrections can be made in a timely manner. As another example, it is important to identify process equipment lifetime issues and limitations as soon as possible before a costly excursion takes place, based on certain clues that may emerge during measurements. Certain embodiments of the present invention provide a method that allows for sampling the wafer surface such that a fraction of the wafer surface area is inspected to provide a signature map of defects.

Some embodiments of the present invention provide an inline examination of process uniformity and allows the convenient isolation of a problem to a particular process step or a unit process operation. Certain embodiments of the present invention provide an efficient inspection method for 300-mm wafers, which hold two and a half times the number of dies on a 200-mm wafer. Some embodiments of the present invention provide a method for detecting within-wafer variations after completion of copper CMP. For example, there may be residue left after CMP in certain regions of the wafer. As another example, the filling process for the contact or via holes might be improperly executed and as a result there could be surface or internal voiding. The voiding may result from the CMP pad age or from problems with the motion that is conducted during the polish or perhaps from the use of inadequate end point detection algorithms, to name a few of the possible causes. Certain embodiments of the present invention provide a desirable balance between throughput, sampling coverage, and resolution. For example, the coverage increases with the percentage of the areas sampled within one die over the entire die area. But high percentage of sampling at a given resolution may reduce throughput such as measured by the number of wafers inspected during a given period of time. Some embodiments of the present invention provide an efficient sampling technique for a design node that is equal to or smaller than the 0.13 μm on a 300-mm wafer with a pixel size less than 0.1 μm.

Various additional objects, features and advantages of the present invention can be more fully appreciated with reference to the detailed description and the accompanying drawings that follow.

### BRIEF DESCRIPTION OF THE DRAWINGS

FIG. 1 is a simplified method for monitoring IC process uniformity according to an embodiment of the present invention;

FIG. 2 is a simplified diagram for selected sample regions according to an embodiment of the present invention;

FIG. 3 is a simplified diagram for SEM images according to an embodiment of the present invention;

FIG. 3 is a simplified diagram for SEM images according to an embodiment of the present invention;

FIG. 4 is a simplified diagram showing background grayscale values according to an embodiment of the present invention;

FIG. 4(a) is a simplified color diagram showing background grayscale values according to another embodiment of the present invention;

FIG. 5 is a simplified diagram showing grayscale values for processed features according to an embodiment of the present invention;

FIG. 5(a) is a simplified color diagram showing grayscale values for processed features according to another embodiment of the present invention;

FIG. 6 is a simplified diagram showing adjusted grayscale values for processed features according to an embodiment of the present invention;

FIG. 6(a) is a simplified color diagram showing adjusted grayscale values for processed features according to another embodiment of the present invention;

FIG. 7 is a simplified diagram for sampling a wafer according to an embodiment of the present invention.

### DETAILED DESCRIPTION OF THE INVENTION

The present invention is directed to integrated circuit (IC) fabrication. More particularly, the invention provides a method and system for examining IC process uniformity. Merely by way of example, the invention has been applied to inline monitoring. But it would be recognized that the invention has a much broader range of applicability.

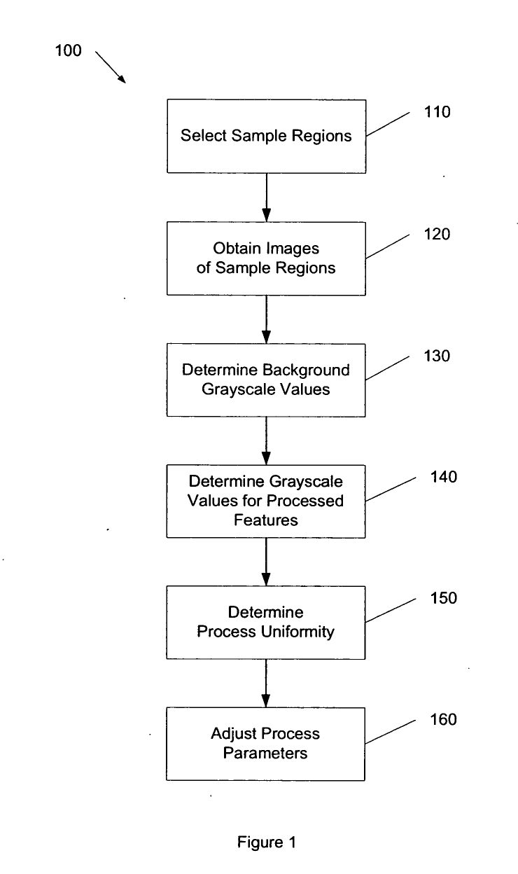

FIG. 1 is a simplified method for monitoring IC process uniformity according to an embodiment of the present invention. This diagram is merely an example, which should not unduly limit the scope of the claims. One of ordinary skill in the art would recognize many variations, alternatives, and modifications. A method 100 includes a process 110 for selecting sample regions, a process 120 for obtaining images of sample regions, a process 130 for determining background grayscale values, a process 140 for determining grayscale values for processed features, a process 150 for determining process uniformity, and a process 160 for adjusting process parameters. Although the above has been shown using a selected group of processes for the method 100, there can be many alternatives, modifications, and variations. For example, some of the processes may be expanded and/or combined. Other processes may be inserted to those noted above. Depending upon the embodiment, the sequence of processes may be interchanged with others replaced. As another example, the processed features that are referred to for the method 100 are the features that are subject to the uniformity determination. The processed features do not include features that have been processed but are not of interest. Further details of these processes are found throughout the present specification and more particularly below.

At the process 110, certain sample regions are selected. Different sample regions may be located in the same die, in different dies on the same wafer, and/or on different wafers. In one embodiment, the sample regions include areas where process-induced defects are frequently found at a rate higher than when the process equipment is operating normally. In another embodiment, the sample region selection is performed based on locations of non-robust tentative design, designated test structures, or areas that have been associated with a high rate of failure. In yet another embodiment, each sample region is contiguous or includes several separate sub-regions. For example, each sub-region includes one or more processed features of interest. As another example, each sample region includes one or more processed features of interest.

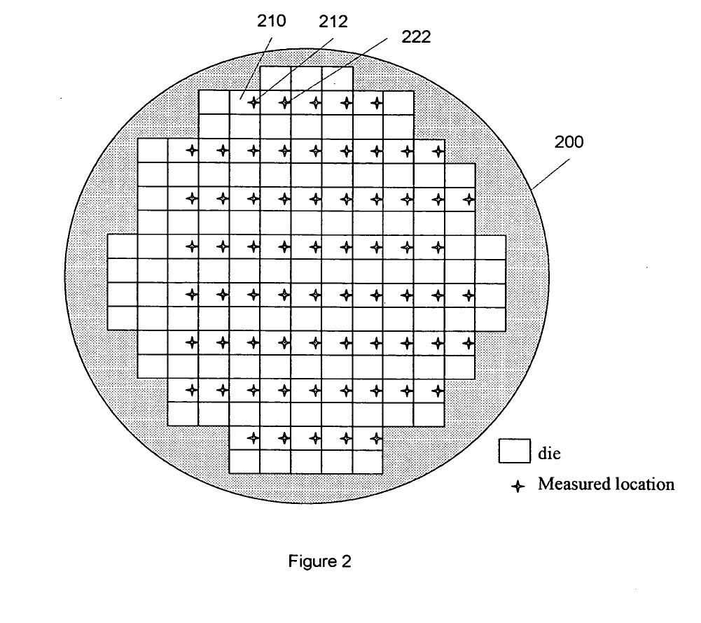

FIG. 2 is a simplified diagram for selected sample regions according to an embodiment of the present invention. This diagram is merely an example, which should not unduly limit the scope of the claims. One of ordinary skill in the art would recognize many variations, alternatives, and modifications. As shown in FIG. 2, on a wafer 200 and within a die 210, one or more specific regions are selected as one sample region 212. Similarly, sample regions are also selected for other dies on the wafer 200. For example, the sample regions have the same location with respect to their corresponding dies. As another example, same and/or similar features are included in different sample regions, and these features are the subject of examination on process uniformity. As another example, the sample regions are defined by a user who creates a recipe file and in this recipe file the location of the sites is defined. There are provisions for wafer map and alignment definition during the recipe creation process.

At the process 120, images of sample regions are obtained with a scanning electron microscope (SEM). For example, an SEM for inspecting semiconductor devices is used with a selected landing energy and high resolution. The SEM includes an electron gun for irradiating a wafer with an electron beam, deflectors that enable one to control the deflection of electrons, a stage on which the wafer is stationed, and a detector for imaging. As another example, an SEM as described in U.S. Pat. Nos. 6,392,231, 6,605,805 and 6,710,342 can be used for image capturing. U.S. Pat. Nos. 6,392,231, 6,605,805 and 6,710,342 are incorporated by reference herein for all purposes. In yet another example, the landing energy, the pixel size, the beam current used, and the averaging chosen for SEM images are all optimized to improve throughput.

In one embodiment, the SEM scans some or all sample regions as shown in FIG. 2, and some or all of the SEM images are saved. In another embodiment, the field of view of the images can be varied but are kept the same for all the images or for a set of images between which comparisons are to be made. In yet another embodiment, various techniques are used to automatically identify the sample regions for imaging based on pattern recognition and automated classification and alignment.

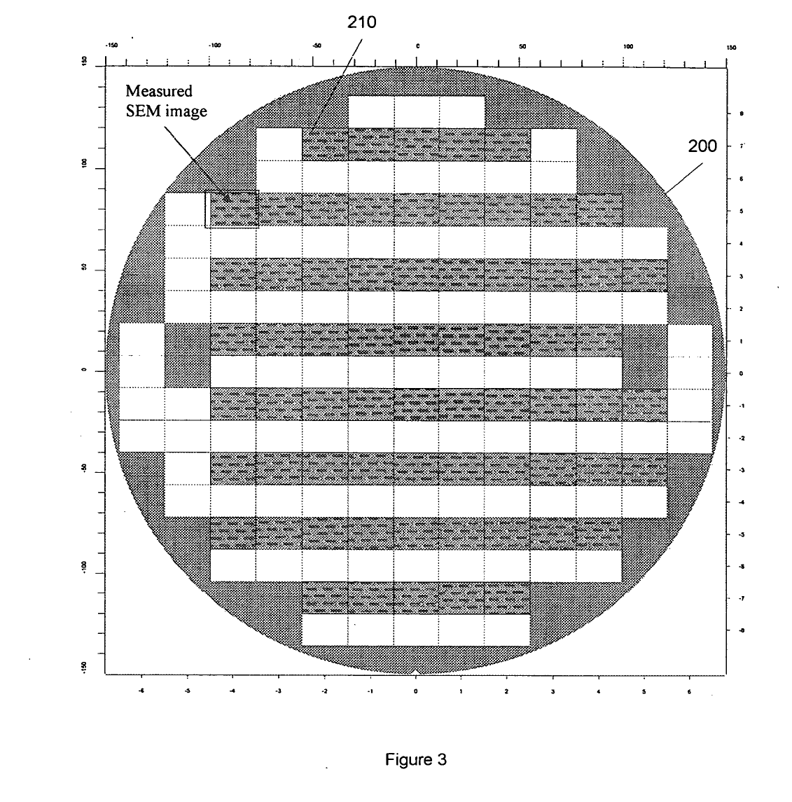

FIG. 3 is a simplified diagram for SEM images according to an embodiment of the present invention. This diagram is merely an example, which should not unduly limit the scope of the claims. One of ordinary skill in the art would recognize many variations, alternatives, and modifications. As shown in FIG. 3, the SEM images for sample regions in various dies are pasted by software into their corresponding dies. For example, the image for the sample region 212 is placed into the die 210. These pasted images pictorially show image variations from die to die across the whole wafer. In another example, each sample region includes several sub-regions, and for each sub-region an image is captured. One or more of these images that correspond to the same sample region are pasted into the die associated with the sample region. In yet another example, a waveform representation of the processed features in various dies is pasted into their corresponding dies. The waveform representation can describe the signal strength verses position near the features of interest. In another example, another method is used to visualize the process uniformity within a die, between dies within a wafer, and/or between wafers.

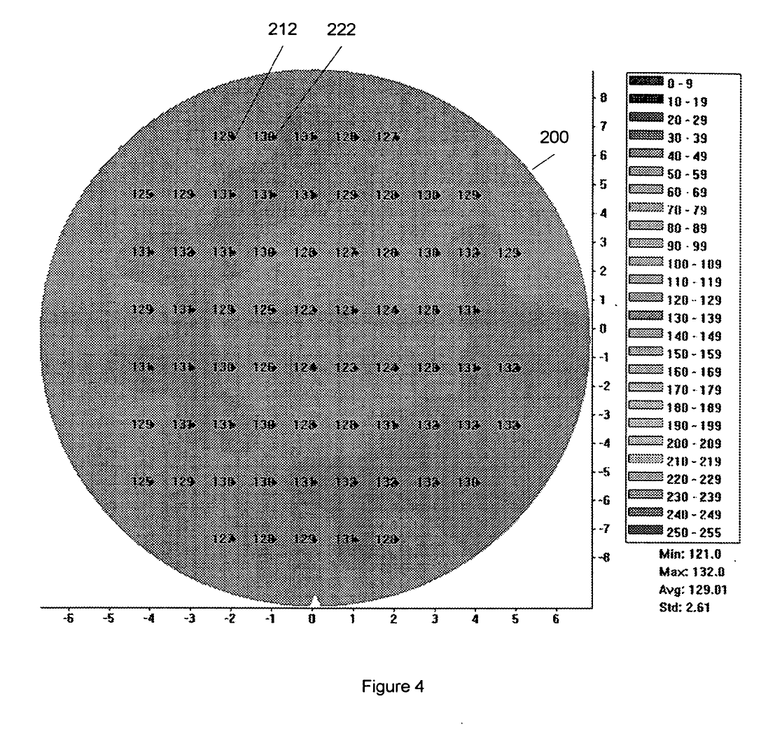

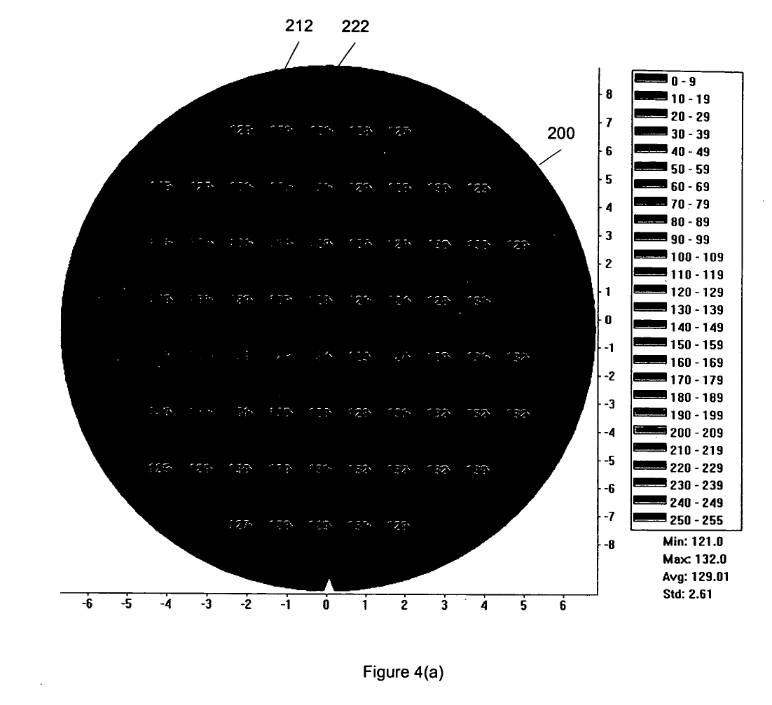

At the process 130, background grayscale values are determined. In one embodiment, each measured SEM image displays two measurable grayscale values, one for processed features and the other for the background. For example, the processed features includes contact and/or via holes, and the background includes the regions without the features of interest, but surrounding it. In another embodiment, average gray scale numbers for the background of each measured SEM image are calculated. FIG. 4 is a simplified diagram showing background grayscale values according to an embodiment of the present invention. This diagram is merely an example, which should not unduly limit the scope of the claims. One of ordinary skill in the art would recognize many variations, alternatives, and modifications. As shown in FIG. 4, the sample region 212 has a background grayscale value of 129, and the sample region 222 has a background grayscale value of 130. For regions outside the sample regions, their background grayscale values are determined by interpolating from the background grayscale values of the sample regions. The interpolation may be linear or non-linear, and may be allowed to take into account background grayscale values of several sample regions. As shown in FIG. 4, the interpolation generates a two-dimensional wafer map showing background grayscale values across the wafer 200. In another example, the background grayscale values are represented in color. Different colors correspond to different ranges of grayscale values. FIG. 4(a) is a simplified color diagram showing background grayscale values according to another embodiment of the present invention. This diagram is merely an example, which should not unduly limit the scope of the claims. One of ordinary skill in the art would recognize many variations, alternatives, and modifications.

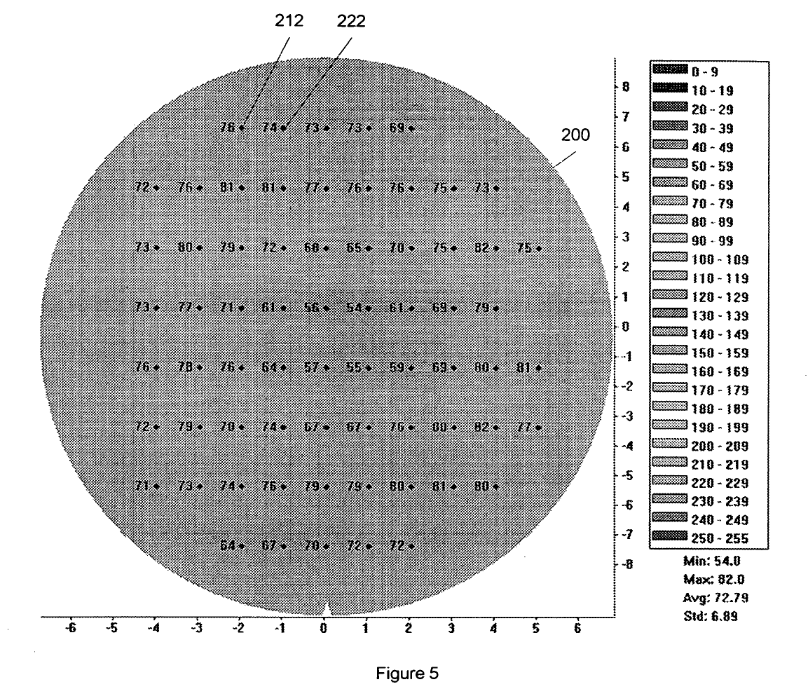

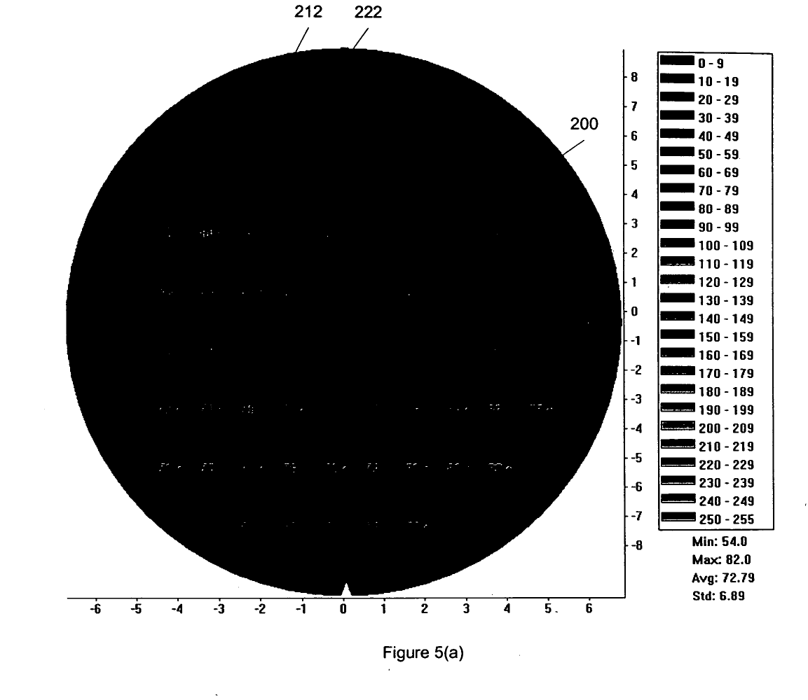

At the process 140, grayscale values for processed features are determined. In one embodiment, each measured SEM image displays two measurable grayscale values, one for processed features and the other for the background. For example, the processed features includes contact and/or via holes, and the background includes the regions without the features of interest. In another embodiment, average gray scale numbers for the processed features of each measured SEM image are calculated. FIG. 5 is a simplified diagram showing grayscale values for processed features according to an embodiment of the present invention. This diagram is merely an example, which should not unduly limit the scope of the claims. One of ordinary skill in the art would recognize many variations, alternatives, and modifications. As shown in FIG. 5, the sample region 212 has a grayscale value of 76, and the sample region 222 has a grayscale value of 74. For regions outside the sample regions, their grayscale values are determined by interpolating from the grayscale values of the sample regions. The interpolation may be linear or non-linear, and may take into account background grayscale values of several sample regions. As shown in FIG. 5, the interpolation generates a two-dimensional wafer map showing grayscale values for the processed features across the wafer 200. The grayscale map shows the differences between the features of interest in different sample regions on the wafer. In another example, the grayscale values for processed features are represented in color. Different colors correspond to different ranges of grayscale values. FIG. 5(a) is a simplified color diagram showing grayscale values for processed features according to another embodiment of the present invention. This diagram is merely an example, which should not unduly limit the scope of the claims. One of ordinary skill in the art would recognize many variations, alternatives, and modifications.

At the process 150, process uniformity is determined based on adjusted grayscale values for processed features. In one embodiment, the adjusted grayscale values are equal to the difference between the grayscale values for the background and the grayscale values for processed features. In one example, the adjusted grayscale values are calculated and stored in a computer. Variations in adjusted grayscale values are representative of process variations. For example, processed features in two different dies and/or in the same die can be compared. In one embodiment, the compared features are nominally identical or qualitatively comparable.

In another embodiment, the image data are summarized by computing statistical process uniformity on the basis of calculation of average and standard deviation of the grayscale values of the background, average and standard deviation of the grayscale values of processed features, and average and standard deviation of the adjusted grayscale values. In one embodiment, process uniformity is measured by the ratio of standard deviation to the average and expressed as a percentage. For example, the standard deviation and the average are calculated based on adjusted gray scale values. If the ratio is equal to or smaller than a predetermined value, the fabrication process or processes associated with the processed features are uniform. If the ratio is larger than the predetermined value, the fabrication process or processes associated with the processed features are deemed to be not uniform.

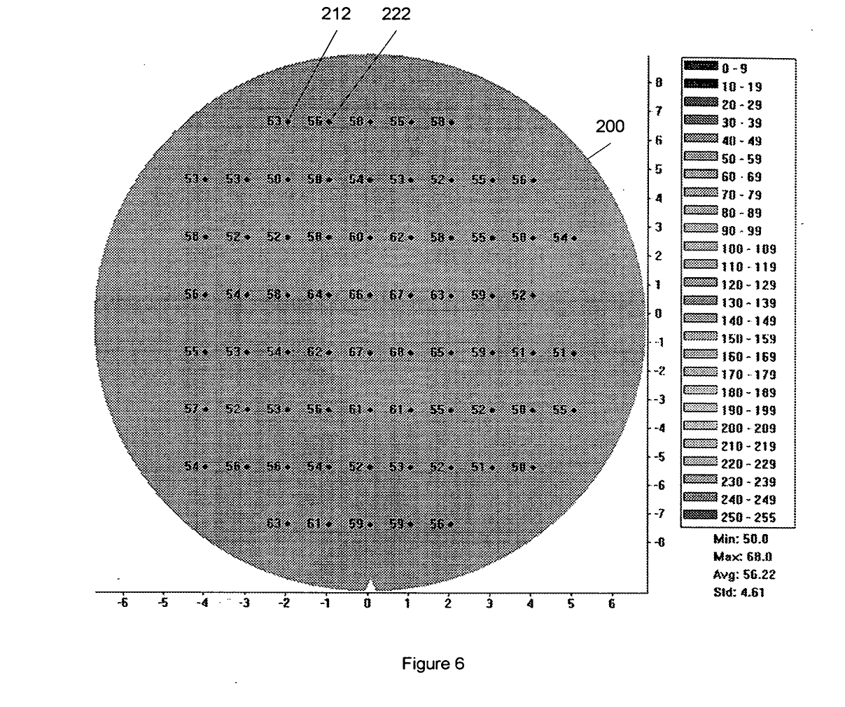

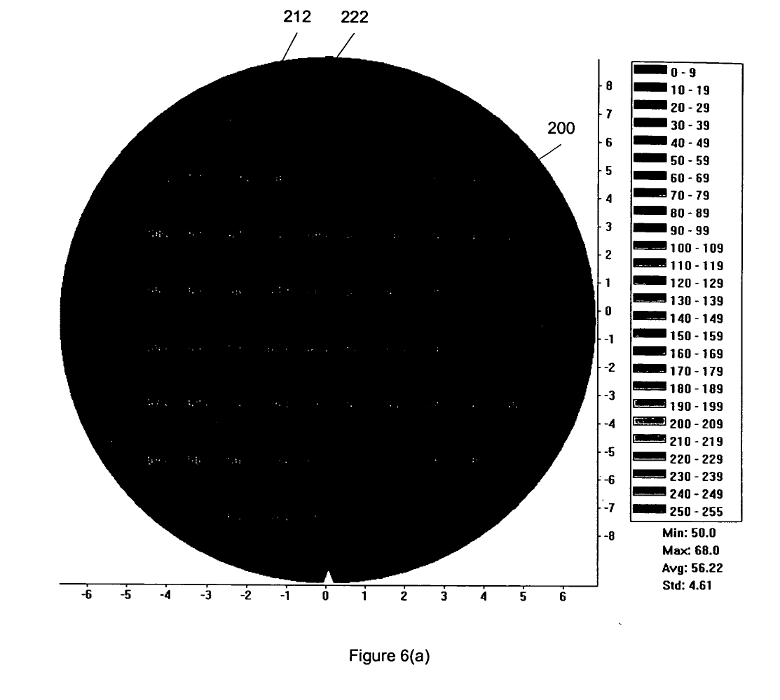

FIG. 6 is a simplified diagram showing adjusted grayscale values for processed features according to an embodiment of the present invention. This diagram is merely an example, which should not unduly limit the scope of the claims. One of ordinary skill in the art would recognize many variations, alternatives, and modifications. As shown in FIG. 6, the sample region 212 has an adjusted grayscale value of 53, and the sample region 222 has an adjusted grayscale value of 56. For regions outside the sample regions, the adjusted grayscale values are determined from their corresponding grayscale values for the background as shown in FIG. 4 and their corresponding grayscale values for the processed features as shown in FIG. 5. As shown in FIG. 6, the resulting adjusted grayscale values can be visualized with a 2-dimensional contour map across the wafer 200. In another example, the adjusted grayscale values are represented in color. Different colors correspond to different ranges of adjusted grayscale values. FIG. 6(a) is a simplified color diagram showing adjusted grayscale values for processed features according to another embodiment of the present invention. This diagram is merely an example, which should not unduly limit the scope of the claims. One of ordinary skill in the art would recognize many variations, alternatives, and modifications.

At the process 160, process parameters are adjusted to improve process performance. For example, the process uniformity determined at the process 150 exceeds a predetermined tolerance. In response, the process parameters are adjusted to reduce such non-uniformity. In another example, a process engineer uses the grayscale values as a proxy for dimensions, topography, and/or content of the processed features, and compares them to corresponding grayscale values of the processed features that have been verified to be satisfactory. If the comparison points out any unacceptable differences, the process parameters are adjusted to improve feature characteristics.

As discussed above and further emphasized here, FIGS. 1-6 including 4(a), 5(a) and 6(a) are merely examples, which should not unduly limit the scope of the claims. One of ordinary skill in the art would recognize many variations, alternatives, and modifications. For example, processes 130 and 150 are skipped, and the process uniformity is determined based on grayscale values obtained at the process 140. In one embodiment, after making sure that the background grayscale values are stable over time under a set of predetermined conditions, the wafer map as shown in FIG. 3 is compared with historical data which indicate acceptable process uniformity. If the wafer map is not as uniform as the historical data, the process may need to be adjusted or fine tuned to improve the process uniformity. In another example, the sample regions selected at the process 110 are processed with fabrication steps before the process 110, or after the process 110 but before the process 120. The uniformity of the fabrication steps is subject to examination by the method 100. In yet another example, the adjusted grayscale values are calibrated with a particular set of conditions after the, sample regions have been processed. In one embodiment, after an etch, a contact hole displays a calibrated grayscale value that is indicative of an under-etch. The process engineer can then adjust process parameters in order to achieve just-etch or slight over-etch, based on the calibrated correlation. Additionally, the parameter modification and other processes of the method 100 can be performed iteratively until a satisfactory uniformity and/or other process objectives are achieved.

In another embodiment, the method 100 captures images at the process 120 with a metrology and/or inspection system other than an e-beam inspection system such as one made by Hermes Microvision, Inc. For example, the system used could be a CD-SEM, a defect review SEM, or a metal thickness measurement system.

In yet another embodiment, various types of grayscale values can be analyzed with different statistical methods in order to monitor process fluctuations. The types of grayscale values include grayscale values for the background and the processed features and adjusted grayscale values. Several types of statistical analyses can be used. For example, uniformity can be measured by the standard deviation of all the data points measured within the wafer divided by the average of all the data points, expressed as a percentage. As another example, the uniformity can be defined as the ratio of the number of detected defects to the number of defined locations. Based on one or more statistical measures, proceeding or not proceeding, or a “go” or “no-go,” can be decided when monitoring the process inline. In yet another embodiment, a satisfactorily processed feature and different kinds of defects can be identified based on automatic defect classification (ADC) training. ADC involves the use of machine learning algorithms to identify defects or features based on their quantifiable characteristics such as dimensions and/or ratio of dimensions.

In yet another embodiment, the method 100 uses a sampling technique by selecting sample regions, analyzing images of sample regions, and determining process uniformity across an entire wafer. Each sample region includes one contiguous region or several separate sub-regions. For each die, the area sampled is usually a percentage of the entire die area. The percentage may vary from lower than 1% to as high as above 99%. For example, the percentage ranges from (1×10⁻¹⁰)% to 100%.

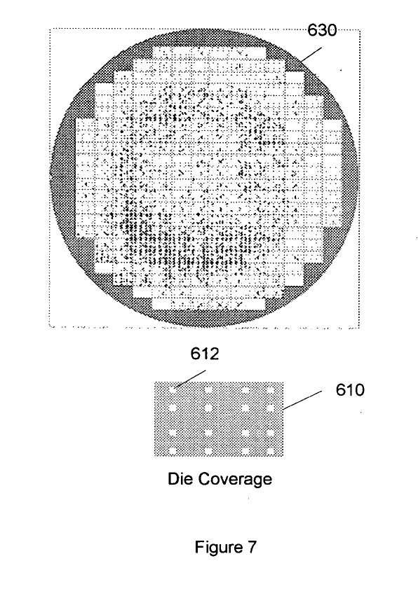

FIG. 7 is a simplified diagram for sampling a wafer according to an embodiment of the present invention. This diagram is merely an example, which should not unduly limit the scope of the claims. One of ordinary skill in the art would recognize many variations, alternatives, and modifications. As shown in FIG. 7, the areas 612 sampled within a die 610 is less than 10% of the entire die area, and the die 610 is located on a wafer 630.

In yet another embodiment, statistical analysis is performed at as many similar locations within a die as possible, after due consideration of the tradeoff between resolution, coverage, and throughput. Each location is used as a sample region or a sub-region of a sample region. The sampling technique used for the method 100 involves scanning an area or multiple contiguous or non-contiguous areas of each die so that the data are sufficient for identification of the signature of a process anomaly at a wafer level or at a part-wafer level. As another example, the signature of a process anomaly can be tracked with respect to time in order to measure the tendency of the anomaly or the physical event that is causing it, to worsen.

There are various types of processed features whose uniformity can be studied by the method 100. In one embodiment, the method 100 is used to examine processed features, whose grayscale values are substantially different from grayscale values of the background. For example, the grayscale values of the processed features are greater than or less than the average grayscale value for the background plus or minus the standard deviation of the grayscale values of the background. In another embodiment, the processed features include unfilled contact and/or via holes. For example, the contact and/or via holes are formed by etching into a dielectric layer that is located on another layer. In one embodiment, the another layer is conductive. At the process 110, sample regions are selected including contact and/or via holes of interest. Different sample regions may be located in the same die, in different dies on the same wafer, and/or on different wafers. At the process 120, SEM images of sample regions are obtained with a selected landing energy. At the selected landing energy, certain characteristics of secondary charged particles are sensitive to the under-etching of the processed contact and/or via holes. As an example, the inventors have discovered that a landing energy substantially equal to or higher than 250 eV, properly optimized, can provide strong correlation between adjusted gray scale values and etching uniformity of contact and/or via holes.

At the process 130, the background grayscale values are determined based on scanned SEM images. These images can provide two measurable grayscale characteristics, one for etched contact and/or via holes and the other for the surrounding background. Additional background grayscale values can be obtained through interpolation. At the process 140, the grayscale values for the etched contact and/or via holes are determined based on scanned SEM images. As discussed above, these images can provide two measurable grayscale characteristics, one for etched contact and/or via holes and the other for the surrounding background. Additional grayscale values for the processed features can be obtained through interpolation.

At the process 150, process uniformity is determined based on adjusted grayscale values. The adjusted grayscale values equal to the differences between the grayscale values for the background and the grayscale values for etched contact and/via holes. The adjusted grayscale values of the processed features may or may not be uniform. Variations in adjusted grayscale values are representative of process variations. For example, two contact holes are both under-etched, and the same thickness of dielectric remains in the contact holes. These contact holes should have substantially the same adjusted grayscale values. As another example, the compared features are contact holes that undergo the same fabrication processes. The contact holes may have the same or different cross-section areas. In yet another example, each sample region includes contact holes with different densities and/or contact holes with different dimensions.

In another embodiment, the adjusted grayscale values are calibrated for a particular set of conditions after contact and/or via holes have been fabricated. For example, such calibration is accomplished by taking cross-sections of the contact and/or via holes and measuring the dielectric thickness associated with corresponding under-etch. The dielectric thickness can then be correlated to a specific value or a specific range of adjusted grayscale values.

At the process 160, the process parameters are adjusted if the non-uniformity of the adjusted grayscale values exceeds a predetermined tolerance. In one embodiment, as shown in FIG. 6, the adjusted grayscale values are visualized as a contour map that clearly shows the etching uniformity or variation across the wafer 200. The etching rate at the center of the wafer 200 is significantly different from other locations. Based on the finding from this contour map, certain parameters of an etch tool can be quickly adjusted or fine-tuned to remedy any non-uniform etch problems or other anomalies observed on the wafer 200.

In yet another embodiment, the method 100 is used to examine filled contact and/or via holes. For example, the contact and/or via holes are formed by etching into a dielectric layer that is located on a conductive layer. These contact and/or via holes are filled with conductive material such as copper and/or tungsten, which is then planarized with chemical mechanical polishing (CMP). With these filled holes, there are at least two types of problems that can be detected. One type of problem is associated with the holes themselves, and includes remaining dielectric material at via bottoms. The other type of problem is associated with the filling material and includes partly enclosed voids or undesirable characteristics of polished surface at each damascene level. For example, after copper electrochemical plating (ECP), there may be undesirable filling material in the trenches that can give rise to voids. As another example, the non-uniformity of the CMP process may result in surface pitting and/or voiding. In yet another example, there can be some residue material left after the CMP process. In yet another example, there exists copper micro-bridging between metal lines.

The method 100 can be used to detect both types of problems and monitor uniformity of the processes that have been performed prior to the inspection. The processed features that are subject to inspection includes filled contact and/or via holes, and/or a portion of metal lines. The adjusted grayscale values can be used to determined uniformity of the processes and optimize the process parameters.

In yet another embodiment, the method 100 is used to examine transistor gates as processed features after poly deposition and gate etch. For example, there may be undesirable polysilicon left in regions other than transistor gates and interconnections. Defects such as poly pillars can create process non-uniformity, which can be detected by the method 100. In yet another embodiment, the method 100 is used to examine junction leakage and gate shorts. The presence of gate oxide as an insulator would usually leave the poly gate in a “floating” electrical condition. Gates shorted to the substrate can generate non-uniformity, which can be detected by the method 100. In response, leaky gate oxide may be identified and remedied. In yet another embodiment, the examination of self-aligned contact, after etch or after tungsten-fill and CMP, can also reveal problems related to certain fabrication processes.

In yet another embodiment of the present invention, processed features are chosen based on either their representativeness or uniqueness. For example, with respect to contact etch, one type of feature choice would be a contact with a frequently occurring contact dimension and surroundings. This feature would be chosen based on its representativeness. In another example, a unique feature would be chosen because the feature has been a failure point.

As discussed above, variations of semiconductor processing may occur between different lots, between wafers within a lot, between dies within a wafer, and/or between regions within a die. Certain embodiments of the present invention can be used to identify such process variations by imaging and analyzing sample regions. These sample regions should be properly selected. For example, if there is a sudden drop-off or increase of a certain parameter in certain locations, these locations should be chosen to reflect such change clearly. As an example, the sudden drop-off or increase may occur at or near wafer edges. In another embodiment, several sample regions are selected from one die in order to examine intra-die variations due to patterning changes and effects such as micro-loading.

In yet another embodiment, the method 100 is used for semiconductor wafer inline monitoring, which measures and represents process uniformity in an easily understandable format. For example, one way for detecting process variations is by inspecting processed features of interest in selected sample regions in their corresponding dies. As another example, grayscale values for the processed features, as well as grayscale values for the background, are determined.

In yet another embodiment, the method 100 is used for inline process monitoring of etch process applied to make contact holes. For example, etching in the dual damascene scheme as well as the subtractive etch scheme involves etching at the contact level and filling the etched hole with tungsten. During such an etch, several problems could arise. Some of the various problems that could be encountered include remaining dielectric left at the bottom of a high aspect ratio contact hole due to under-etch, etch residue left at the bottom of the hole, and over etch. As another example, the method 100 selects a sample region includes one or more locations in a wafer die and incorporate the location information into a recipe for automatically or manually reaching the one or more locations. In yet another example, the processed features of interest are ones with a high frequency of defects, or they are intentionally designed features.

In one embodiment, the method 100 includes the setup of an electron microscope for imaging followed by collection of the images. The images of the processed features of interest are obtained all over the wafer and pasted on the location of the die in a two-dimensional depiction of the wafer. For quantitative representation purposes, grayscale values of the processed features such as contact holes and grayscale values for the surrounding background are also taken at each sample region. Using these grayscale data, a background contour map, a feature contour map and a difference contour map are all computed and depicted, for example, as shown in FIGS. 4, 5, and 6. These two-dimensional contour maps are plotted to facilitate understanding of the uniformity of the background and of the process performance at the selected features.

In another embodiment, the method 100 is used to analyze contact holes, via holes and trenches that have been filled. In yet another embodiment, the processed features for the method 100 include gate structures resulting from conductive layer deposition and etch. For example, the process non-uniformity may come from gate leakage, poly pillars such as small poly particles left on the surface, and poly pitting, all of which are caused by issues in the tool responsible for the unit operations of poly deposition and etch. In yet another embodiment, the method 100 is used to examine self-aligned contact, which is after etch, or after tungsten-fill and CMP.

In yet another embodiment, a semiconductor wafer metrology and inspection method can efficiently measure and portray the process uniformity. For example, the method 100 collects grayscale data on each die of interest and maps the overall data for enhanced visualization of the overall processing uniformity. As another example, the method 100 uses a high-resolution SEM to scan each die at one or more selected locations. For each SEM image, the grayscale value for the processed features or the adjusted grayscale value are computed and used to characterize the uniformity. These grayscale values, as well as grayscale levels of the background, are represented in two-dimensional or three-dimensional contour maps to better visualize the overall etching uniformity or variation. In yet another example, multiple regions within a die are imaged. These multiple regions may be used as one or more sample regions.

In yet another embodiment of the present invention, an inline and offline process monitoring method, such as the method 100, for semiconductor wafer inspection is provided. The method is performed using electron beam irradiation after a unit process operation on a plurality of dies has been completed. The location of the processed feature, in each die, is selected by the user, and the background includes regions that surround the processed feature but are distinctly different from the processed feature. The feature location on each die is scanned and grayscale images for the feature and the background are stored corresponding to each location. In one embodiment, each sample region includes one or more processed features. For example, the processed features of interest are nominally identical based on process designs. As another example, each sample region includes several processed features. The grayscale values for the sample region is an average calculated by dividing the sum of the grayscale values of all the features by the number of the processed features within the sample region.

In yet another example, the image data are processed by computing and displaying the contour plots in two dimensions. The contour plots show the location of the die against the grayscale value of the processed feature, grayscale value of the background, and the adjusted grayscale value respectively. In yet another example, the image data are processed by computing and displaying the contour plots in three dimensions. The contour plots show the location of the die against the grayscale value of the processed feature, gray scale value of the background, and adjusted grayscale value respectively. The two dimensions are the location of the die such as (x,y) or (r, θ) on the wafer, and the other dimension is the grayscale. The annotation involves a representation of the feature size, and the wafer is represented as a circle.

In yet another example, the image data are summarized by computing statistical process uniformity on the basis of calculation of average and standard deviation of the grayscale values of the background, average and standard deviation of the grayscale values of processed features, and average and standard deviation of the adjusted grayscale values. In one embodiment, process uniformity is measured by the ratio of standard deviation to the average and expressed as a percentage. In yet another example, the captured images are automatically pasted onto a two dimensional representation of the wafer as a circle so that the viewer can get a visual indication of the process uniformity by looking at the images pasted on to die locations.

The method can be used to examine uniformity of various processes for integrated circuit fabrication. For example, the method is used to examine uniformity of an etching process for via or contact hole. After the etching process is completed, the images of sample regions are captured including one or more unfilled contact holes, vias, or trenches. In one example, a via refers to a contact hole. In another example, a via refers to a trench, such as one used for shallow trench isolation. In yet another example, the method is used to examine uniformity of a metal filling and polishing process. After the chemical mechanical polishing of metal layer, which also fills contact holes, the images of sample regions are captured and they can include one or more filled contact holes, vias, or trenches. The metal layer may include copper and/or tungsten. In yet another example, the method is used to examine uniformity of a poly etching process. After the etching process is completed, the images of sample regions are captured including one or more polysilicon gates resulting from the polysilicon etch. In yet another example, the method is used to examine uniformity of a self-aligned contact fabrication process. After the self-aligned fabrication process is completed, the images of sample regions are captured, including, one or more self-aligned contacts, prior to and after tungsten fill, followed by tungsten CMP.

In yet another embodiment of the present invention, an inline and offline process monitoring method, such as the method 100, uses a sampling technique for the entire wafer. The method is performed using electron beam irradiation after a unit process operation on a plurality of dies. The locations of the processed features in each die are selected by the user, and the background includes regions that surround the processed features but is distinctly different from the processed features. The feature locations on each die are scanned and grayscale images for the features and the background are stored corresponding to each location. In one embodiment, each sample region includes one or more separated sub-regions, each of which covers one or more processed features. In another embodiment, the sampled areas within a particular die is a percentage of the entire die area, and the percentage can range from less than 1% to 100%. For example, the percentage ranges from (1×10⁻¹⁰)% to 100%.

In yet another embodiment, a method such as the method 100 calibrates the adjusted grayscale values with certain feature characteristics such as topography, dimensions or content, and establishes quantitative correspondence between feature characteristics and adjusted grayscale values. For example, the method may be used to examine process variations within a wafer or within a die. As another example, the method is used to iteratively optimize process parameters until desired feature characteristics are achieved.

According to yet another embodiment, a system for determining process uniformity includes an electron microscope system configured to obtain a plurality of electron microscope images associated with a plurality of sample regions respectively. The plurality of sample regions includes a plurality of processed features, and each of the plurality of sample regions includes at least one of the plurality of processed features. Each of the plurality of processed features results from at least one fabrication process. Additionally, the system includes a processing system configured to process information associated with the plurality of electron microscope images, and determine a first plurality of grayscale values for the plurality of sample regions respectively based on at least information associated with the plurality of electron microscope images. Each of the first plurality of grayscale values is associated with the at least one of the plurality of processed features. Moreover, the processing system is further configured to process information associated with the first plurality of grayscale values, and determine whether the at least one fabrication process is uniform based on at least information associated with the first plurality of grayscale values. In one embodiment, the processing system includes software and/or hardware. In another embodiment, the system is used to implement the method 100.

According to yet another embodiment, a system for determining process uniformity includes an electron microscope system configured to obtain a plurality of electron microscope images associated with a plurality of sample regions respectively. The plurality of sample regions includes a plurality of processed features, and each of the plurality of sample regions includes at least one of the plurality of processed features. Each of the plurality of processed features results from at least one fabrication process. Additionally, the system includes a processing system configured to process information associated with the plurality of electron microscope images, and determine a first plurality of grayscale values for the plurality of sample regions respectively based on at least information associated with the plurality of electron microscope images. Each of the first plurality of grayscale values is associated with the at least one of the plurality of processed features. Moreover, the processing system is further configured to generate a first contour map based on at least information associated with the first plurality of grayscale values, process information associated with the first contour map, and determine whether the at least one fabrication process is uniform based on at least information associated with the first contour map. In one embodiment, the processing system includes software and/or hardware. In another embodiment, the system is used to implement the method 100.

The present invention has various advantages over conventional techniques. Some embodiments of the present invention provide a semiconductor wafer measurement and inspection technique to accurately monitor and visualize processing conditions such as uniformity or variation of particular processes within a die, within a wafer, between wafers within a lot, and/or between lots. Certain embodiments of the present invention provide contour maps representing average grayscale values for the background, average grayscale values for processed features, and adjusted grayscale values. These two-dimensional contour maps can serve as reliable indicators of overall process conditions across an entire wafer and/or between wafers. Some embodiments of the present invention provide quick visual representation using sample region images as well as grayscale values for the processed features and the background. For example, the visual representation takes the form of contour plots and clearly shows wafer level variations. Certain embodiments of the present invention use sample regions within a die to determine process uniformity within a die or designated sample regions within a wafer to determine the process uniformity within a wafer. Some embodiments of the present invention enable a process engineer to get a quick synopsis of the process performance across the wafer, supported by statistically quantitative measures. For example, a lot of data can be generated by e-beam inspection, which may be highly voluminous to handle and thereby making its significance difficult to understand. With quick visualization and comparative analysis of the data in a concise manner, appropriate process corrections can be made in a timely manner. As another example, it is important to identify process equipment lifetime issues and limitations as soon as possible before a costly excursion takes place, based on certain clues that may emerge during measurements. Certain embodiments of the present invention provide a method that allows for sampling the wafer surface such that a fraction of the wafer surface area is inspected to provide a signature map of defects.

Some embodiments of the present invention provide an inline examination of process uniformity and allows the convenient isolation of a problem to a particular process step or a unit process operation. Certain embodiments of the present invention provide an efficient inspection method for 300-mm wafers, which hold two and a half times the number of dies on a 200-mm wafer. Some embodiments of the present invention provide a method for detecting within-wafer variations after completion of copper CMP. For example, there may be residue left after CMP in certain regions of the wafer. As another example, the filling process for the contact or via holes might be improperly executed and as a result there could be surface or internal voiding. The voiding may result from the CMP pad age or from problems with the motion that is conducted during the polish or perhaps from the use of inadequate end point detection algorithms, to name a few of the possible causes. Certain embodiments of the present invention provide a desirable balance between throughput, sampling coverage, and resolution. For example, the coverage increases with the percentage of the areas sampled within one die over the entire die area. But high percentage of sampling at a given resolution may reduce throughput such as measured by the number of wafers inspected during a given period of time. Some embodiments of the present invention provide an efficient sampling technique for a design node that is equal to or smaller than the 0.13 μm on a 300-mm wafer with a pixel size less than 0.1 μm.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

1. A method for determining process uniformity, the method comprising:
selecting a plurality of sample regions, the plurality of sample regions including a plurality of processed features, each of the plurality of sample regions including at least one of the plurality of processed features, each of the plurality of processed features resulting from at least one fabrication process;
obtaining a plurality of electron microscope images associated with the plurality of sample regions respectively;
processing information associated with the plurality of electron microscope images;
determining a first plurality of grayscale values for the plurality of sample regions respectively based on at least information associated with the plurality of electron microscope images, each of the first plurality of grayscale values being associated with the at least one of the plurality of processed features;
processing information associated with the first plurality of grayscale values;
determining whether the at least one fabrication process is uniform based on at least information associated with the first plurality of grayscale values.

2. The method of claim 1 wherein the processing information associated with the plurality of electron microscope images comprises:
determining a plurality of background grayscale values for the plurality of sample regions respectively based on at least information associated with the plurality of electron microscope images;
determining a second plurality of grayscale values for the plurality of sample regions respectively based on at least information associated with the plurality of electron microscope images, each of the second plurality of grayscale values being associated with the at least one of the plurality of processed features.

3. The method of claim 2 wherein the determining a first plurality of grayscale values comprises determining a plurality of differences between the second plurality of grayscale values and the plurality of background grayscale values respectively.

4. The method of claim 2, and further comprising generating a contour map based on at least information associated with the second plurality of grayscale values.

5. The method of claim 2, and further comprising generating a contour map based on at least information associated with the plurality of background grayscale values.

6. The method of claim 1 wherein each of the plurality of sample regions comprises a plurality of separate sub-regions.

7. The method of claim 1 wherein the plurality of sample regions are located on a wafer, the wafer including a plurality of dies, each of the plurality of dies including at least one of the plurality of sample regions.

8. The method of claim 1 wherein the plurality of sample regions are located on a plurality of wafers, each of the plurality of wafers including at least one of the plurality of sample regions.

9. The method of claim 1 wherein at least some of the plurality of sample regions are located in one die.

10. The method of claim 1 wherein the obtaining a plurality of electron microscope images comprises using a secondary electron microscope.

11. The method of claim 10 wherein the secondary electron microscope is selected from a group consisting of a defect inspection SEM, a defect review SEM, and a CD-SEM.

12. The method of claim 1 wherein the plurality of processed features comprises a plurality of vias resulting from etching a portion of a dielectric layer, the dielectric layer being on a first surface of a first conductive layer.

13. The method of claim 12 wherein the determining whether the at least one fabrication process is uniform comprises determining whether the etching for the plurality of vias is uniform.

14. The method of claim 12 wherein the plurality of vias are free from being filled with a second conductive layer.

15. The method of claim 14 wherein the determining whether the at least one fabrication process is uniform comprises determining whether the plurality of vias are associated with the same depth of etching.

16. The method of claim 12 wherein:
the plurality of vias are filled with a second conductive layer;
the second conductive layer is planarized by a chemical mechanical polishing process.

17. The method of claim 16 wherein the second conductive layer comprises at least one selected from a group consisting of copper and tungsten.

18. The method of claim 1 wherein the plurality of processed features comprises a plurality of transistor gates resulting from depositing and etching a conductive layer.

19. The method of claim 18 wherein the conductive layer comprises polysilicon.

20. The method of claim 1 wherein the plurality of processed features comprises a plurality of transistor junctions.

21. The method of claim 1 wherein the plurality of processed features comprises a plurality of self-aligned contacts.

22. The method of claim 1 wherein the processing information associated with the first plurality of grayscale values comprises generating a contour map based on at least information associated with the first plurality of grayscale values.

23. The method of claim 22 wherein:
the contour map includes information associated with a third plurality of grayscale values corresponding to a plurality of locations;
the third plurality of grayscale values includes the first plurality of grayscale values;
the plurality of locations includes the plurality of sample regions.

24. The method of claim 23 wherein the generating a contour map comprises determining at least some of the third plurality of grayscale values based on at least information associated with the first plurality of grayscale values.

25. The method of claim 24 wherein the determining at least some of the third plurality of grayscale values comprises interpolating at least some of the first plurality of grayscale values.

26. The method of claim 1 wherein the determining whether the at least one fabrication process is uniform comprises:
determining a standard deviation and an average based on at least information associated with the first plurality of grayscale values;
determining a ratio between the standard deviation to the average.

27. The method of claim 26 wherein the determining whether the at least one fabrication process is uniform further comprises:
processing information associated with the ratio and a predetermined value;
determining the at least one fabrication process to be uniform if the ratio is equal to or smaller than the predetermined value;
determining the at least one fabrication process to be not uniform if the ratio is larger than the predetermined value.

28. The method of claim 1, and further comprising adjusting one or more process parameters in response to whether the at least one fabrication process is uniform, the one or more process parameters related to the at least one fabrication process.

29. The method of claim 1, and further comprising calibrating each of the first plurality of grayscale values with a plurality of characteristic values related to one or more characteristics of the plurality of processed features.

30. The method of claim 29 wherein the calibrating each of the first plurality of grayscale values comprises determining a plurality of corresponding relationships between the first plurality of grayscale values and the plurality of characteristic values.

31. The method of claim 1 wherein the selecting a plurality of sample regions comprises selecting the plurality of sample regions from a wafer, the total area of the plurality of sample regions equal to the total area of the wafer multiplied by a ratio.

32. The method of claim 31 wherein the ratio ranges from (1×10⁻¹⁰)% to 100%.

33. A method for determining process uniformity, the method comprising:
selecting a plurality of sample regions, the plurality of sample regions including a plurality of processed features, each of the plurality of sample regions including at least one of the plurality of processed features, each of the plurality of processed features resulting from at least one fabrication process;
obtaining a plurality of electron microscope images associated with the plurality of sample regions respectively;
processing information associated with the plurality of electron microscope images;
determining a first plurality of grayscale values for the plurality of sample regions respectively based on at least information associated with the plurality of electron microscope images, each of the first plurality of grayscale values being associated with the at least one of the plurality of processed features;
generating a first contour map based on at least information associated with the first plurality of grayscale values;
processing information associated with the first contour map;
determining whether the at least one fabrication process is uniform based on at least information associated with the first contour map.

34. The method of claim 33 wherein:
the first contour map includes information associated with a second plurality of grayscale values corresponding to a plurality of locations;
the second plurality of grayscale values includes the first plurality of grayscale values;
the plurality of locations includes the plurality of sample regions.

35. The method of claim 34 wherein the generating a first contour map comprises determining at least some of the second plurality of grayscale values based on at least information associated with the first plurality of grayscale values.

36. The method of claim 35 wherein the determining at least some of the second plurality of grayscale values comprises interpolating at least some of the first plurality of grayscale values.

37. The method of claim 33 wherein the processing information associated with the plurality of electron microscope images comprises:
determining a plurality of background grayscale values for the plurality of sample regions respectively based on at least information associated with the plurality of electron microscope images;
determining a third plurality of grayscale values for the plurality of sample regions respectively based on at least information associated with the plurality of electron microscope images, each of the third plurality of grayscale values being associated with the at least one of the plurality of processed features.

38. The method of claim 37 wherein the determining a first plurality of grayscale values comprises determining a plurality of differences between the third plurality of grayscale values and the plurality of background grayscale values respectively.

39. The method of claim 37, and further comprising generating a second contour map based on at least information associated with the third plurality of grayscale values.

40. The method of claim 37, and further comprising generating a second contour map based on at least information associated with the plurality of background grayscale values.

41. The method of claim 33 wherein each of the plurality of sample regions comprises a plurality of separate sub-regions.

42. The method of claim 33 wherein the plurality of sample regions are located on a wafer, the wafer including a plurality of dies, each of the plurality of dies including at least one of the plurality of sample regions.

43. The method of claim 33 wherein the plurality of sample regions are located on a plurality of wafers, each of the plurality of wafers including at least one of the plurality of sample regions.

44. The method of claim 33 wherein at least some of the plurality of sample regions are located in one die.

45. The method of claim 33, and further comprising adjusting one or more process parameters in response to whether the at least one fabrication process is uniform, the one or more process parameters related to the at least one fabrication process.

46. The method of claim 33, and further comprising calibrating each of the first plurality of grayscale values with a plurality of characteristic values related to one or more characteristics of the plurality of processed features.

47. The method of claim 46 wherein the calibrating each of the first plurality of grayscale values comprises determining a plurality of correspondence relationships between the first plurality of grayscale values and the plurality of characteristic values.

48. A system for determining process uniformity, the system comprising:
an electron microscope system configured to obtain a plurality of electron microscope images associated with a plurality of sample regions respectively, the plurality of sample regions including a plurality of processed features, each of the plurality of sample regions including at least one of the plurality of processed features, each of the plurality of processed features resulting from at least one fabrication process;
a processing system configured to:
process information associated with the plurality of electron microscope images;
determine a first plurality of grayscale values for the plurality of sample regions respectively based on at least information associated with the plurality of electron microscope images, each of the first plurality of grayscale values being associated with the at least one of the plurality of processed features;
process information associated with the first plurality of grayscale values;
determine whether the at least one fabrication process is uniform based on at least information associated with the first plurality of grayscale values.

49. The system of claim 48 wherein the process information associated with the plurality of electron microscope images comprises:
determine a plurality of background grayscale values for the plurality of sample regions respectively based on at least information associated with the plurality of electron microscope images;
determine a second plurality of grayscale values for the plurality of sample regions respectively based on at least information associated with the plurality of electron microscope images, each of the second plurality of grayscale values being associated with the at least one of the plurality of processed features.

50. The system of claim 49 wherein the determine a first plurality of grayscale values comprises determine a plurality of differences between the second plurality of grayscale values and the plurality of background grayscale values respectively.

51. The system of claim 49 wherein the processing system is further configured to generate a contour map based on at least information associated with the second plurality of grayscale values.

52. The system of claim 49 wherein the processing system is further configured to generate a contour map based on at least information associated with the plurality of background grayscale values.

53. The system of claim 48 wherein each of the plurality of sample regions comprises a plurality of separate sub-regions.

54. The system of claim 48 wherein the plurality of sample regions are located on a wafer, the wafer including a plurality of dies, each of the plurality of dies including at least one of the plurality of sample regions.

55. The system of claim 48 wherein the plurality of sample regions are located on a plurality of wafers, each of the plurality of wafers including at least one of the plurality of sample regions.

56. The system of claim 48 wherein at least some of the plurality of sample regions are located in one die.

57. The system of claim 48 wherein the electron microscope system comprises a secondary electron microscope.

58. The system of claim 57 wherein the secondary electron microscope is selected from a group consisting of a defect inspection SEM, a defect review SEM, and a CD-SEM.

59. The system of claim 48 wherein the plurality of processed features comprises a plurality of vias resulting from etching a portion of a dielectric layer, the dielectric layer being on a first surface of a first conductive layer.

60. The system of claim 59 wherein the determine whether the at least one fabrication process is uniform comprises determine whether the etching for the plurality of vias is uniform.

61. The system of claim 59 wherein the plurality of vias are free from being filled with a second conductive layer.

62. The system of claim 61 wherein the determine whether the at least one fabrication process is uniform comprises determine whether the plurality of vias are associated with the same depth.

63. The system of claim 59 wherein:
the plurality of vias are filled with a second conductive layer;
the second conductive layer is planarized by a chemical mechanical polishing process.

64. The system of claim 63 wherein the second conductive layer comprises at least one selected from a group consisting of copper and tungsten.

65. The system of claim 48 wherein the plurality of processed features comprises a plurality of transistor gates resulting from depositing and etching a conductive layer.

66. The system of claim 65 wherein the conductive layer comprises polysilicon.

67. The system of claim 48 wherein the plurality of processed features comprises a plurality of transistor junctions.

68. The system of claim 48 wherein the plurality of processed features comprises a plurality of self-aligned contacts.

69. The system of claim 48 wherein the process information associated with the first plurality of grayscale values comprises generate a contour map based on at least information associated with the first plurality of grayscale values.

70. The system of claim 69 wherein:
the contour map includes information associated with a third plurality of grayscale values corresponding to a plurality of locations;
the third plurality of grayscale values includes the first plurality of grayscale values;
the plurality of locations includes the plurality of sample regions.

71. The system of claim 70 wherein the generate a contour map comprises determine at least some of the third plurality of grayscale values based on at least information associated with the first plurality of grayscale values.

72. The system of claim 71 wherein the determine at least some of the third plurality of grayscale values comprises interpolate at least some of the first plurality of grayscale values.

73. The system of claim 48 wherein the determine whether the at least one fabrication process is uniform comprises:
determine a standard deviation and an average based on at least information associated with the first plurality of grayscale values;
determine a ratio between the standard deviation to the average.

74. The system of claim 73 wherein the determine whether the at least one fabrication process is uniform further comprises:
process information associated with the ratio and a predetermined value;
determine that the at least one fabrication process to be uniform if the ratio is equal to or smaller than the predetermined value;
determine that the at least one fabrication process to be not uniform if the ratio is larger than the predetermined value.

75. The system of claim 48 wherein the processing system is further configured to adjust one or more process parameters in response to whether the at least one fabrication process is uniform, the one or more process parameters related to the at least one fabrication process.

76. The system of claim 48 wherein the processing system is further configured to calibrate each of the first plurality of grayscale values with a plurality of characteristic values related to one or more characteristics of the plurality of processed features.

77. The system of claim 76 wherein the calibrate each of the first plurality of grayscale values comprises determine a plurality of corresponding relationships between the first plurality of grayscale values and the plurality of characteristic values.

78. The system of claim 48 wherein the plurality of sample regions are selected from a wafer, the total area of the plurality of sample regions equal to the total area of the wafer multiplied by a ratio.

79. The method of claim 78 wherein the ratio ranges from (1×10⁻¹⁰)% to 100%.

80. A system for determining process uniformity, the method comprising:
an electron microscope system configured to obtain a plurality of electron microscope images associated with a plurality of sample regions respectively, the plurality of sample regions including a plurality of processed features, each of the plurality of sample regions including at least one of the plurality of processed features, each of the plurality of processed features resulting from at least one fabrication process;
a processing system configured to:
process information associated with the plurality of electron microscope images;
determine a first plurality of grayscale values for the plurality of sample regions respectively based on at least information associated with the plurality of electron microscope images, each of the first plurality of grayscale values being associated with the at least one of the plurality of processed features;
generate a first contour map based on at least information associated with the first plurality of grayscale values;
process information associated with the first contour map;
determine whether the at least one fabrication process is uniform based on at least information associated with the first contour map.

81. The system of claim 80 wherein:
the first contour map includes information associated with a second plurality of grayscale values corresponding to a plurality of locations;
the second plurality of grayscale values includes the first plurality of grayscale values;
the plurality of locations including the plurality of sample regions.

82. The system of claim 81 wherein the generate a first contour map comprises determine at least some of the second plurality of grayscale values based on at least information associated with the first plurality of grayscale values.

83. The system of claim 82 wherein the determine at least some of the second plurality of grayscale values comprises interpolate at least some of the first plurality of grayscale values.

84. The system of claim 80 wherein the process information associated with the plurality of electron microscope images comprises:
determine a plurality of background grayscale values for the plurality of sample regions respectively based on at least information associated with the plurality of electron microscope images;
determine a third plurality of grayscale values for the plurality of sample regions respectively based on at least information associated with the plurality of electron microscope images, each of the third plurality of grayscale values being associated with the at least one of the plurality of processed features.

85. The system of claim 84 wherein the determine a first plurality of grayscale values comprises determine a plurality of differences between the third plurality of grayscale values and the plurality of background grayscale values respectively.

86. The system of claim 84 wherein the processing system is further configured to generate a second contour map based on at least information associated with the third plurality of grayscale values.

87. The system of claim 84 wherein the processing system is further configured to generate a second contour map based on at least information associated with the plurality of background grayscale values.

88. The system of claim 80 wherein each of the plurality of sample regions comprises a plurality of separate sub-regions.

89. The system of claim 80 wherein the plurality of sample regions are located on a wafer, the wafer including a plurality of dies, each of the plurality of dies including at least one of the plurality of sample regions.

90. The system of claim 80 wherein the plurality of sample regions are located on a plurality of wafers, each of the plurality of wafers including at least one of the plurality of sample regions.

91. The system of claim 80 wherein at least some of the plurality of sample regions are located in one die.

92. The system of claim 80 wherein the processing system is further configured to adjust one or more process parameters in response to whether the at least one fabrication process is uniform, the one or more process parameters related to the at least one fabrication process.

93. The system of claim 80 wherein the processing system is further configured to calibrate each of the first plurality of grayscale values with a plurality of characteristic values related to one or more characteristics of the plurality of processed features.

94. The system of claim 93 wherein the calibrate each of the first plurality of grayscale values comprises determine a plurality of corresponding relationships between the first plurality of grayscale values and the plurality of characteristic values.
